(19) United States
(12) Patent Application Publication
(10) Pub. No.: US 2016/0152261 A1
(43) Pub. Date: Jun. 2, 2016

(54) HYDRAULIC SYSTEM WITH MARGIN BASED FLOW SUPPLEMENTATION

(71) Applicant: Caterpillar Inc., Peoria, IL (US)

(72) Inventors: Beau D. Kuipers, Morris, IL (US); Sudheer Holenarasipura, Oswego, IL (US); Patrick W. Sullivan, JR., Orland Park, IL (US)

(73) Assignee: Caterpillar Inc., Peoria, IL (US)

(21) Appl. No.: 15/016,277

(22) Filed: Feb. 5, 2016

(51) Int. Cl. B62D 5/14

(52) U.S. Cl. CPC B62D 5/14

(57) ABSTRACT

A hydraulic system with margin based flow supplementation is provided. The hydraulic system includes a steering pump, an implement pump and a flow sharing device. The steering pump is associated with a steering circuit. The implement pump is associated with an implement circuit. The flow sharing device is disposed between the steering circuit and the implement circuit and is configured to operate in one of a first mode and a second mode. Further, the flow sharing device allows hydraulic fluid to flow from the implement circuit to the steering circuit in the first mode, when a margin pressure of the steering circuit is below a threshold value, and the flow sharing device stops the hydraulic fluid to flow from the implement circuit to the steering circuit in the second mode, when the margin pressure of the steering circuit is equal to or above the threshold value.

### TECHNICAL FIELD

The present disclosure relates to hydraulic systems for machines having a hydraulically assisted steering and implements systems and more specifically, to a hydraulic system for sharing fluid flow from an implement circuit to a steering circuit based on a margin pressure threshold of the steering system.

### BACKGROUND

Various machines, for example, wheel loaders, excavators, motor graders, dump vehicles, are used for a variety of purposes. These machines employ hydraulic systems to operate steering components and implement components to accomplish the various tasks. In certain machine configurations, a prime mover, a diesel engine, for example, drives dedicated steering and implement pumps that further provide hydraulic power to the steering and implement components. Flow of hydraulic fluid in hydraulic circuits of such systems depends on the size and performance characteristics of the pumps and on engine speed. For certain situations, operators desire to maintain a low engine speed for controllability of certain implement and other machine functions or for fuel efficiency. Thus, the pump speeds are reduced, limiting the flow available. This may hamper the steering performance, since the lower engine speed limits the available flow out of steering pump.

A solution to the low engine speed situation is to utilize a larger displacement pump for steering, but this approach is more expensive. Another, related, solution is to utilize this larger pump, or an even larger pump, for both steering and implement circuits. In such circuits, the flow is generally controlled with a priority valve to divide between steering and implements, with priority given to the steering circuit. The priority valve can be quite large due to the total implement and steering system flow rate.

U.S. Pat. No. 8,756,930 (hereinafter reference ‘930’) discloses a hydraulic system having a steering hydraulic circuit including a steering pump with variable displacement and being load-sense controlled. The hydraulic system also has an implement hydraulic circuit including an implement pump with variable displacement and being electro-hydraulically controlled. The hydraulic system further has a flow-sharing valve arrangement configured to selectively direct the fluid flow from the steering circuit to the implement circuit. However, the hydraulic system in the reference ‘930’ directs the flow from the steering circuit to the implement circuit that resultantly does not provide improved steering performance. Therefore, there is a need for a hydraulic system that provides improved, or more optimally consistent, steering performance (cycle times) across the full range of operating engine speeds, by utilizing the total pump flow available shared between the steering circuit and the implement circuit.

### SUMMARY OF THE DISCLOSURE

In one aspect of the present disclosure, a hydraulic system with margin based flow supplementation is provided. The hydraulic system includes a steering pump, an implement pump and a flow sharing device. The steering pump is associated with a steering circuit and a given performance. The implement pump is associated with an implement circuit and a given performance. The flow sharing device is disposed between the steering circuit and the implement circuit and is configured to operate in one of a first mode and a second mode. Further, the flow sharing device allows hydraulic fluid to flow from the implement circuit to the steering circuit in the first mode, when a margin pressure of the steering circuit is below a threshold value, and the flow sharing device stops the hydraulic fluid to flow from the implement circuit to the steering circuit in the second mode, when the margin pressure of the steering circuit is equal to or above the threshold value.

### BRIEF DESCRIPTION OF THE DRAWINGS

FIG. 1 is a perspective view of a machine utilizing proposed hydraulic system, in accordance with the concepts of the present disclosure;

FIG. 2 is a schematic view of the hydraulic system for sharing hydraulic fluid flow, in accordance with the concepts of the present disclosure;

FIG. 3 is a schematic view of the hydraulic system for sharing the hydraulic fluid flow via a solenoid operated valve, in accordance with an embodiment of the present disclosure; and

FIG. 4 is a flowchart of a method for sharing the hydraulic fluid flow, in accordance with the concepts of the present disclosure.

### DETAILED DESCRIPTION

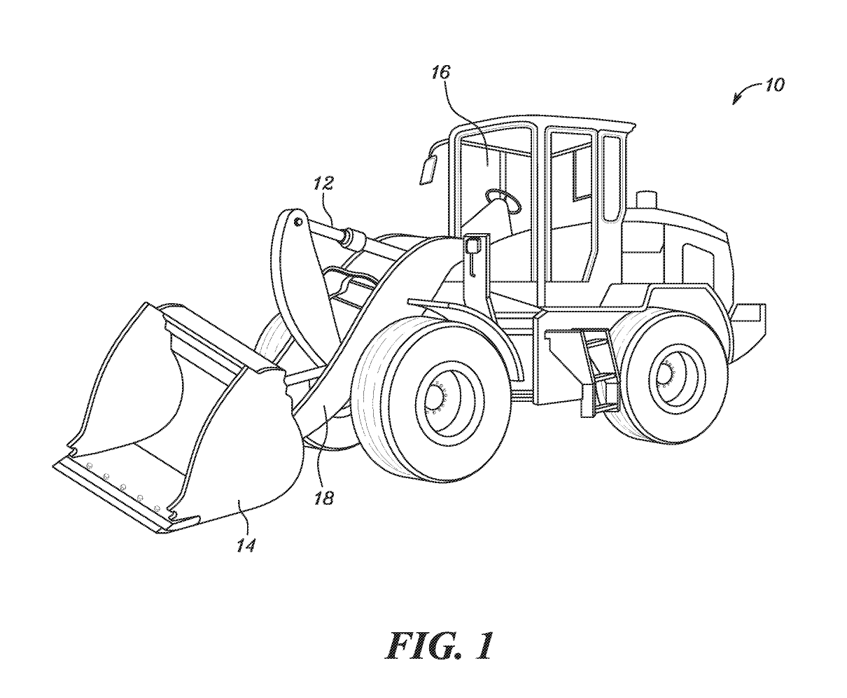

Referring to FIG. 1, a machine 10 includes a hydraulic component 12, a bucket 14, a cabin 16, a boom 18, etc. Machine 10 may include various other components, such as an actuator, a valve, a tank, a controller, a display device, and so on (not shown). For the purpose of simplicity, the various other components of the machine 10 are not labeled in FIG. 1. Examples of machines 10 include, but not limited to, a wheel loader, a motor grader, a track-type tractor, a wheeled scraper, etc. The machine 10 is utilized for a variety of tasks, such as for excavating, hauling, scraping, pushing materials, etc. The machine 10 may be an excavator, or a wheel loader or motor grader. The hydraulic components 12 use power from the prime mover and convert it into hydraulic energy which is subsequently converted into a mechanical motion to operate various components of machine 10, such as steering components, implement components, and auxiliary components. The machine 10 utilizes the proposed hydraulic system for sharing fluid flow from an implement circuit to a steering circuit as described in various embodiments of the disclosure.

The machine 10 also includes a steering component and an implement component (not shown). The steering component and the implement component may be driven by a power source to steer the machine 10 and to move relative to a frame, respectively. It will be apparent to one skilled in the art that there may be varied steering components of the machine 10, such as hydraulically-powered articulation joints and/or traction devices to perform a steering function, and the implement component may be varied such as hydraulically powered implements such as shovels, buckets, and blades to perform an implement function, without departing from the meaning and scope of the present disclosure.

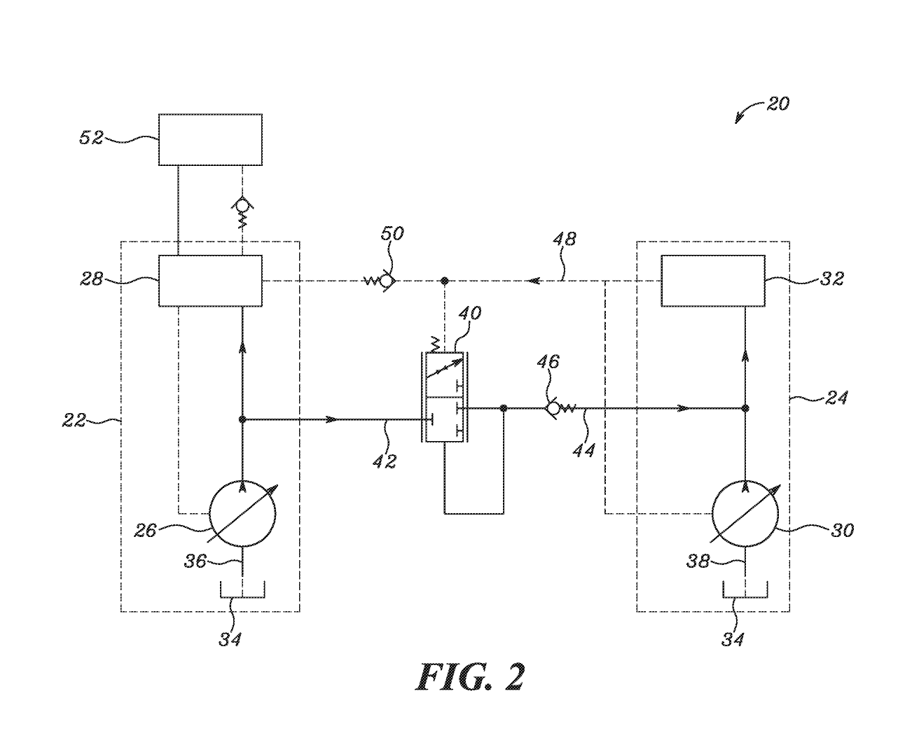

Referring to FIG. 2, the hydraulic system 20 includes an implement circuit 22 and a steering circuit 24. The implement circuit 22 provides a pressurized hydraulic fluid to hydraulic valves and actuators, cylinders for example, (not shown) to move the implement components (not shown). The steering circuit 24 provides a pressurized hydraulic fluid to hydraulic valves and actuators (not shown) to move the steering components, thereby to steer the machine 10. Hereinafter, the terms “hydraulic fluid” and “fluid” can be interchangeably used within the detailed description without departing from the meaning and scope of the present disclosure.

The implement circuit 22 includes an implement pump 26 to draw hydraulic fluid from a reservoir 34 via tank passage 36. The implement pump 26 pressurizes the hydraulic fluid and directs the pressurized hydraulic fluid to the hydraulic actuators connected with the implement components by a way of an implement valve 28. In an embodiment, the implement pump 26 has a variable displacement and is load sensed controlled. In an alternate embodiment, the implement pump could be electro-hydraulically controlled.

The steering circuit 24 includes a steering pump 30 to draw hydraulic fluid from the reservoir 34 via a tank passage 38. The steering pump 30 pressurizes the hydraulic fluid and directs the pressurized hydraulic fluid to the hydraulic actuators connected with the steering components via a steering valve 32. In an embodiment, the steering pump 30 has a variable displacement and is load-sense controlled. In an alternate embodiment, the steering pump is electro-hydraulically controlled.

The steering circuit 24 and the implement circuit 26 are in fluid communication via a flow sharing device 40. The flow sharing device 40 is disposed in between the implement pump 26 and the steering pump 30, via flow passages 42 and 44 respectively. The flow sharing device 40 is a pressure reducing valve, or a flow control valve, or a compensator, or a similar performing device. In some situations, for example, operating at a low engine speed, discharge flow from the steering pump 30 may not be sufficient to have desired steering performance. In another situation, such as when the hydraulic fluid is not utilized by the implement pump 26, the excess hydraulic fluid may be shared with the steering circuit 24. Therefore, in these circumstances, the flow sharing device 40 is controlled to share excess hydraulic fluid from the implement circuit o the steering circuit 24.

The flow sharing device 40 operates in a first mode and a second mode. In the first mode, when a demand of hydraulic fluid arises in the steering circuit 24, the flow sharing device 40 allows the hydraulic fluid to flow from the implement circuit 22 to the steering circuit 24 via the flow passages 42 and 44 and a check valve 46. The steering circuit 24 maintains a margin pressure at which the hydraulic fluid is discharged from the steering pump 30 and is acceptable at inlet of the steering valve 32. The steering circuit 24 maintains the margin pressure at a preset value. In certain conditions, such as at lower engine speed and high steering flow demand, the steering pump 30 is unable to maintain pump margin. In a steady state, the flow sharing device 40 monitors the margin pressure of the steering circuit 24. As the margin pressure of the steering circuit 24 drops below a threshold value of pressure (also called a threshold value), the flow sharing device 40 is activated to direct the excess hydraulic fluid from the implement circuit 22 to the steering circuit 24.

The steering valve 32 is connected with a load sensing line 48 for directing a load sense signal to the flow sharing device 40. Hence, the flow sharing device 40 senses when the margin pressure drops below the threshold value. In an embodiment, the flow sharing device 40 is hydro-mechanically controlled.

The amount of the hydraulic fluid flow required at the steering circuit 24 is sensed via the load sense line 48 and the check valve 50 that connects the steering pump 30 with the implement pump 26. The load sense line 48 communicates the load sense signal to the implement valve 28 for indicating required compensation of the hydraulic fluid in implement circuit 22. In this way, the implement pump 26 provides required hydraulic fluid to the steering circuit 24 to compensate depreciation in discharge of the steering pump 30.

In the second mode, the flow sharing device 40 stops the hydraulic fluid to flow from the implement circuit 22 to the steering circuit 24, when the margin pressure of the steering circuit 24 is equal to or above the threshold value. The check valve 46 prevents flow from the steering circuit 24 to the implement circuit

The hydraulic system 20 may also include an auxiliary valve 52 to provide pressurized hydraulic fluid to hydraulic actuators of auxiliary components of the machine 10, which are other than the steering circuit 24 and the implement circuit 22.

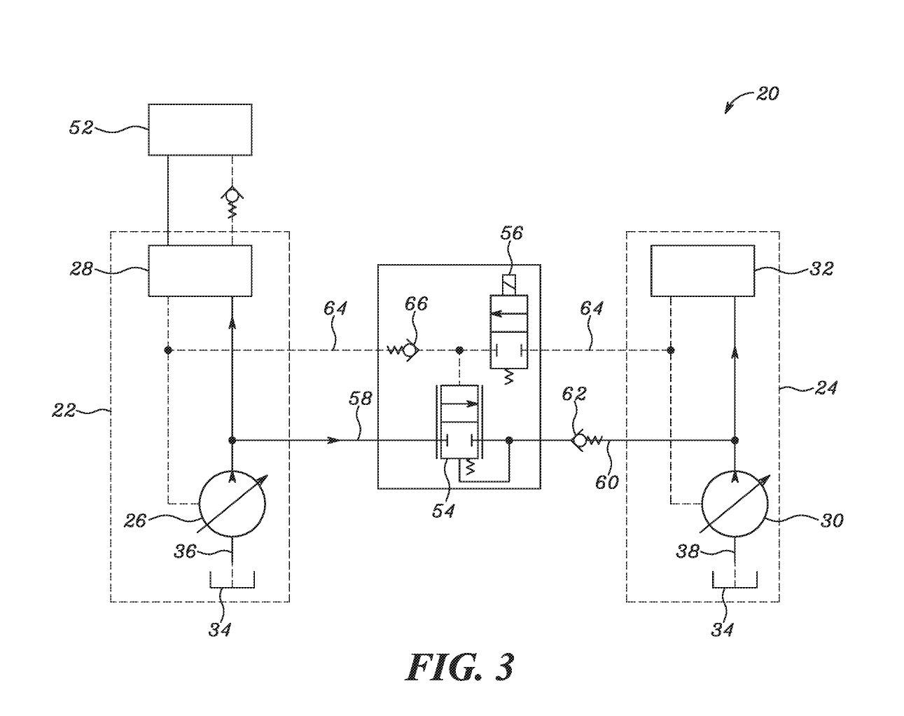

Referring to FIG. 3, a flow control valve 54, in this embodiment, is connected to the steering circuit 24 to identify situations when the margin pressure of the steering circuit 24 drops below the threshold value. As a result, when the margin pressure drops below the threshold value, the flow control valve 54 allows the hydraulic fluid to be shared from the implement circuit 22 to the steering circuit 24 via flow passages 58 and 60 and a check valve 62. The check valve 62 prevents flow from the steering circuit 24 to the implement circuit 22.

As shown in FIG. 3, the solenoid operated valve 56 is placed at a load sense line 64 of the steering circuit 24. Therefore, the solenoid operated valve 56 directs a load sense signal from the steering valve 32 to the implement valve 28 via the load sense line 64 and a check valve 66. The activation and control of the solenoid operated valve 56 may depend on different machine operating conditions, which may include, but is not limited to engine speed of machine 10, implement commands and steering commands. In an embodiment, the solenoid operated valve 56 is an ON/OFF valve.

### INDUSTRIAL APPLICABILITY

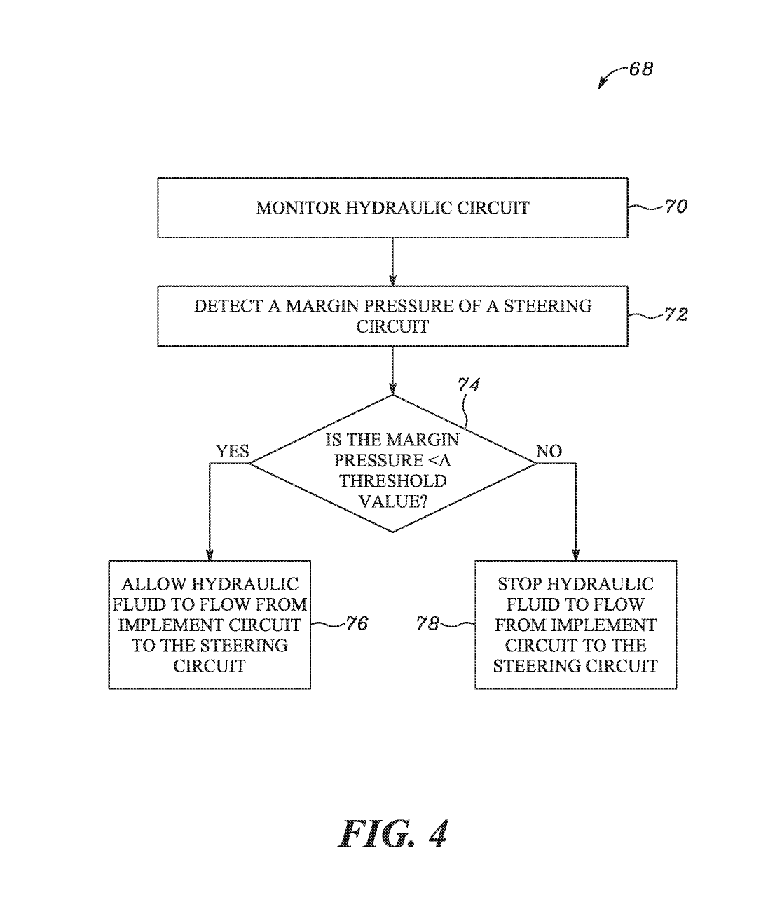

Referring to FIG. 4, a method 68 is described in conjunction with the FIGS. 1-3.

At step 70, the hydraulic system 20 is monitored during steady state. The flow sharing device 40 keeps a check on the functioning of the steering circuit 24 and the implement circuit 22.

At step 72, the flow sharing device 40 detects the margin pressure of the steering circuit 24.

At step 74, the flow sharing device 40 senses whether the margin pressure of the steering circuit 24 drops below the threshold value.

At step 76, if the margin pressure of the steering circuit 24 drops below the threshold value, the flow sharing device 40 activates and allows the hydraulic fluid to flow from the implement circuit 22 to the steering circuit 24.

At step 78, if the margin pressure is not below the threshold value, the hydraulic system 20 operates in the steady state and the flow sharing device 40 is not activated.

The hydraulic system 20 includes the flow sharing device 40 to share the hydraulic fluid from the implement circuit 22 to the steering circuit 24, when the margin pressure of the steering circuit 24 is below the threshold value. Therefore, in situations like lower engine speed. When implement components are not operating; the steering components may not be supplied with enough hydraulic fluid flow. As a result, the steering performance is reduced. There may exists excess hydraulic fluid in the implement circuit 22 that is not utilized by the implement circuit 22. This excess hydraulic fluid is shared from the implement circuit 22 to the steering circuit 24 via the flow sharing device 40. In this way, the steering performance is maintained ideally even at lower engine speed.

The flow sharing device 40 handles lower amounts of hydraulic fluid when compared to typical flow sharing hardware. Therefore, the flow sharing device 40 is smaller in size and cost and machine space claim is also reduced. It also must be recognized, the proposed hydraulic system 20 neither impact regulations nor critical performance of the machine 10.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A hydraulic system for a machine, the hydraulic system comprising:
a steering pump associated with a steering circuit;
an implement pump associated with an implement circuit; and
a flow sharing device disposed between the steering circuit and implement circuit, the flow sharing device is configured to operate in one of a first mode and a second mode;
wherein the flow sharing device allows a hydraulic fluid to flow from the implement circuit to the steering circuit in the first mode, when a margin pressure of the steering circuit is below a threshold value, and the flow sharing device stops the hydraulic fluid to flow from the implement circuit to the steering circuit in the second mode, when the margin pressure of the steering circuit is equal to or above the threshold value.
